(19) United States
(12) Patent Application Publication
(10) Pub. No.: US 2015/0096518 A1
(43) Pub. Date: Apr. 9, 2015

(54) VEHICLE STARTING SYSTEM

(71) Applicant: Remy Technologies, LLC, Pendleton, IN (US)

(72) Inventors: Alex Creviston, Muncie, IN (US); Bradley D. Chamberlin, Pendleton, IN (US)

(21) Appl. No.: 14/049,876

(22) Filed: Oct. 9, 2013

(51) Int. Cl. F02N 11/08; F02N 11/04

(52) U.S. Cl. CPC F02N 11/0833; F02N 11/04
USPC 123/179.4; 123/179.1; 123/179.3

(57) ABSTRACT

A starting system for an internal combustion engine is disclosed. During a key-start, a starter assembly is used to initiate rotation of the engine crankshaft. After the engine speed reaches a transfer speed, an alternator is used to supply torque to the engine until the engine is started. In some embodiments, the starter motor is de-energized while the alternator is cranking the engine and before the engine is started. The same battery pack is used to power both the starter motor and the alternator when starting the engine. An automatic start-stop system is also disclosed. When automatically restarting the engine, the alternator alone is used to restart the engine if it is still coasting above a restart engine speed. If the engine speed is below the restart engine speed, the starter motor initially cranks the engine when restarting the engine.

### BACKGROUND

The present invention relates to starting systems for vehicles with internal combustion engines.

Vehicles having an internal combustion engine generally rely upon either a starter motor or a motor/generator to turn over the engine during the starting of the engine.

Starter motors typically have a pinion gear which can be moved into and out of engagement with a ring gear located on the outer perimeter of a flywheel attached to the crankshaft of the engine. During a starting event a battery supplies the starter motor with electrical current and the pinion gear is engaged with the ring gear to rotate the flywheel and, thus, the crankshaft of the engine. When the rotational speed of the engine reaches a threshold value, fuel is introduced into the engine to start the engine. Once the combustion of fuel begins and the engine has started, the pinion gear of the starter is disengaged from the ring gear and the starter motor is de-energized.

Vehicles having such a starter motor will also typically have a separate generator that is used to recharge the battery when the engine is running. Typically, the crankshaft will have a flywheel with ring gear mounted on one end of the engine and a pulley located on the other end of the crankshaft on the opposite end of the engine. This pulley will power the generator by means of a belt which couples the engine pulley to a pulley on the generator. Often, other devices, such as a water pump for circulating coolant, are also belt driven and powered by a pulley located on the crankshaft at this end of the engine.

Another type of starter often used with internal combustion engines is commonly referred to as a belt-alternator-starter or “BAS” system. In a BAS system, there is no separate starter motor having a pinion gear which engages a ring gear on the flywheel. Instead, the generator is motor/generator or “alternator” which operates as a motor to start the engine and then operates as a generator after the engine is running. When using this type of alternator, it is typically located on the end of the engine where the crankshaft has a pulley and coupled thereto with a belt. The alternator transmits torque to the crankshaft to start the engine by means of the belt. Similarly, the belt is used to transmit torque to the alternator to recharge the battery when the engine is running.

As a general rule, the demands placed on the alternator are greatest when starting the engine. Thus, in a vehicle having both a starter and a generator, the generator will typically be smaller than an alternator would be for that same vehicle. The two different types of starter systems also have different operating characteristics. Generally, a separate starter which uses a pinion for engaging a ring gear will be capable of delivering a greater torque to the crankshaft while a BAS system will typically be able to generate a higher engine speed. This is due in part to the difference between gears and belts when transferring torque and the different reduction ratios employed by starters and alternators which allow alternators to remain coupled to the engine at higher engine speeds. For example, a conventional starter motor might have a reduction ratio of 10:1, wherein the starter motor rotates 10 times for each rotation of the crankshaft, while a conventional alternator might have a reduction ratio of 4:1.

Vehicles with automatic start-stop systems are becoming an increasingly popular way to reduce fuel consumption and limit exhaust. Hybrid vehicles which rely on both an internal combustion engine and an electrical motor for providing torque to the drive train of the vehicle typically include such automatic start-stop systems. Conventional vehicles which rely solely upon an internal combustion engine for propulsion, however, are also being equipped with such automatic start-stop systems.

Both dedicated starter motors and BAS systems can be used with such automatic start-stop systems. In automatic start-stop systems, the electronic control unit (“ECU”) of the vehicle intentionally stops the engine based upon the operating conditions of the vehicle and subsequently restarts the engine based upon the operating conditions of the vehicle. This stopping and starting of the engine occurs without the operator of the vehicle actively stopping or starting the engine.

Hybrid vehicles often employ a stop-start system to temporarily stop the operation of the internal combustion engine when the vehicle is brought to a stop or when the forward propulsion of the vehicle can be entirely provided by an electric traction motor. When used in a non-hybrid vehicle reliant entirely on an internal combustion engine for propulsion, the stop-start system will typically only stop the engine when the brake is being applied and the vehicle is being brought to a stop or when the vehicle is stopped. The use of a stop-start system in such vehicles will, thereby, typically turn off the engine when the vehicle is stopped and in an idling situation. By automatically turning off the engine in such idling situations, the stop-start system not only enhances fuel-economy but also reduces emissions.

In many vehicles having an automatic start-stop system, the starter used to initially start the engine is also used when the ECU automatically restarts the engine after stopping the engine as a part of a stop-start system. The start-stop system may also have “change-of-mind” capabilities whereby it is able to restart the engine very shortly after the engine was stopped and the fly-wheel, and crankshaft attached thereto, is still inertially rotating or “coasting.”

In BAS systems, the belt coupling the alternator with the crankcase means that the alternator will already be coupled with the crankcase when it is desired to restart the engine. This allows BAS systems to more easily restart a “coasting” engine.

For dedicated starter systems, the pinion gear is disengaged after the initial starting of the engine and will be disengaged when it is desired to restart the engine. If the engine has completely stopped and the flywheel has stopped rotating, the engine can be restarted in the same manner that it is started as in a key-start when the operator of the vehicle starts a cold engine.

If the flywheel of the engine is still rotating when it is desired to restart the engine, the system must either delay the restart until the flywheel stops or nearly stops rotating or by energizing the starter motor to rotate the pinion gear and only engaging the pinion gear with the ring gear after the speeds of the ring gear and pinion gear have been synchronized.

While automatic start-stop systems can be used with both BAS and dedicated starter systems, further improvements in starter systems and, particularly for automatic start-stop systems, remain desirable.

### SUMMARY

The present invention provides a starter system for a vehicle which utilizes both a dedicated starter motor and an alternator when starting the internal combustion engine of the vehicle and is particularly well adapted for use in automatic start-stop systems.

The invention comprises, in one form thereof, a starting system for an internal combustion engine with a crankshaft. A battery pack is conductively coupled with the starting system. A starter assembly is operably coupled with the starting system and has a starter motor coupled with the crankshaft whereby the starter assembly is selectively operable to deliver torque to the crankshaft. An electric machine is operably coupled with the starting system. The electric machine is coupled with the crankshaft and is selectively operable as a motor delivering torque to the crankshaft and as a generator recharging the battery pack. An electronic control unit is operably coupled with the starting system and controls operation of the starter assembly and electric machine. During a key-start of the engine, the starter assembly supplies torque to the crankshaft to initiate rotation of the crankshaft and the electric machine supplies torque to the crankshaft after a first predetermined engine speed is reached during the starting process. Both the starter motor and the electric machine are powered solely by the battery pack when starting the engine.

In some embodiments, the starter motor is de-energized at a second predetermined engine speed and the electric machine stops transferring torque to the crankshaft at a third engine speed which is greater than the second predetermined engine speed wherein the third engine speed corresponds to autonomous engine combustion. In such an embodiment the second predetermined engine speed may advantageously be at least as great as the first predetermined engine speed. In still other embodiments, the first and second predetermined engine speeds are substantially similar and the torque respectively supplied by the electric machine and the starter motor at the first and second predetermined engine speeds is substantially similar.

Other embodiments may combine the starting system with an automatic start-stop system wherein the electronic control unit is adapted to automatically start and stop the engine. In one embodiment of such a system, when restarting the engine, the electronic control unit determines if the engine speed is at least as great as a fourth predetermined engine speed and, if the engine speed is at least as great as the fourth predetermined engine speed, restarts the engine by supplying torque to the crankshaft with the electric machine without energizing the starter motor and wherein the electric machine is powered solely by the battery pack when restarting the engine. In such a system, the fourth predetermined engine speed may advantageously be less than the first predetermined engine speed.

For some embodiments of such a system, if the engine speed is less than both the fourth predetermined engine speed and a fifth predetermined engine speed, the engine is restarted by initially supplying torque to the crankshaft with the starter assembly and, after reaching the first predetermined engine speed, supplying torque to the crankshaft with the electric machine wherein both the starter motor and the electric machine are powered solely by the battery pack when restarting the engine. In embodiments the fourth and fifth predetermined engine speeds are the same. In others, the fifth predetermined engine speed is less than the fourth predetermined engine speed.

For systems where the fifth engine speed is less than the fourth engine speed, restarting the engine when the engine speed is between the fifth and fourth speeds may be accomplished in various manners. In one embodiment, when the electronic control unit determines the engine speed is between the fourth and fifth predetermined engine speeds and a restart is desired, the electronic control unit delays supplying torque to the crankshaft with the starter motor until the engine speed falls below the fifth predetermined engine speed. In such an embodiment, the starter motor may be coupled with the crankshaft and energized at substantially the same time when initiating the supply of torque to the crankshaft.

In another embodiment, when the electronic control unit determines the engine speed is below the fifth predetermined engine speed and a restart is desired, the starter motor coupled with the crankshaft and energized at substantially the same time when initiating the supply of torque to the flywheel; and, when the electronic control unit determines the engine speed is between the fourth and fifth predetermined engine speeds and a restart is desired, the starter motor is energized while uncoupled from the crankshaft and the starter motor is coupled to the crankshaft to initiate the supply of torque to the crankshaft when the rotational speeds of the starter motor and the crankshaft are synchronized.

The crankshaft of the engine may have a flywheel and engine pulley coupled thereto. In such applications, the starter assembly advantageously includes a gear coupled with the starter motor and selectively coupled with the flywheel whereby the starter assembly selectively delivers torque to the crankshaft. Additionally, a first pulley is advantageously coupled with the electric machine and a belt couples the first pulley with the engine pulley to thereby transfer torque between the crankshaft and the electric machine. In such an embodiment, the reduction ratios of the starter motor and electric machine may be such that, when both the starter assembly and the electric machine are coupled to the crankshaft during rotation of the crankshaft, the starter motor will define a greater rotational speed than the electric machine.

In some embodiments, the battery pack is a nominal 48 volt battery pack. The starting system of such an embodiment may be adapted to start a diesel engine.

The invention comprises, in another embodiment thereof, an automatic start-stop system for an internal combustion engine with a crankshaft. The start-stop starting system includes a battery pack conductively coupled with the start-stop system. A starter assembly is also operably coupled with the start-stop system and has a starter motor selectively coupled to the crankshaft whereby the starter assembly is selectively operable to deliver torque to the crankshaft. An electric machine is operably coupled with the start-stop system and is coupled with the crankshaft. The electric machine is selectively operable as a motor delivering torque to the crankshaft and as a generator recharging the battery pack. An electronic control unit is operably coupled with the start-stop system and controls operation of the starter assembly and electric machine. During a key-start of the engine, the starter assembly supplies torque to the crankshaft to initiate rotation of the crankshaft. When restarting the engine, the electronic control unit determines if the engine speed is at least as great as a predetermined restart speed and, if the engine speed is at least as great as the restart speed, restarts the engine by supplying torque to the crankshaft with the electric machine and without energizing the starter motor. The battery pack is the sole source of electrical energy for the starter motor and the electrical machine when starting and restarting the engine.

In some embodiments, the battery pack is a nominal 48 volt battery pack.

The crankshaft of the engine may have a flywheel and engine pulley coupled thereto. In such applications, the starter assembly advantageously includes a gear coupled with the starter motor and selectively coupled with the flywheel whereby the starter assembly selectively delivers torque to the crankshaft. A first pulley is advantageously coupled with the electric machine and a belt couples the first pulley with the engine pulley to thereby transfer torque between the crankshaft and the electric machine. Advantageously, when both the starter assembly and the electric machine are coupled to the crankshaft during rotation of the crankshaft, the starter motor will define a greater rotational speed than the electric machine.

In some embodiments having a gear coupled with the starter motor and a first pulley coupled to the electric machine, during a key-start of the engine, the starter assembly supplies torque to the flywheel to initiate rotation of the crankshaft and the electric machine supplies torque to the engine pulley after the engine speed reaches a predetermined transfer speed during the starting process. The starter motor is de-energized when the engine reaches a predetermined hand-off speed and the electric machine stops transferring torque to the engine pulley when the engine reaches a termination speed which is greater than the hand-off speed, the termination speed corresponding to autonomous engine combustion.

In such a start-stop system, if the engine speed is less than the restart speed when a restart is desired, the restart of the engine can be initiated by supplying torque to the flywheel with the starter assembly. In still other embodiments, when a restart is desired and the electronic control unit determines the engine speed is between the restart speed and a predetermined low-speed threshold that is less than the restart speed, the electronic control unit delays supplying torque to the flywheel with the starter motor until the engine speed falls below the low-speed threshold and wherein the pinion gear is coupled with the flywheel and the starter motor is energized at substantially the same time when initiating the supply of torque to the flywheel.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a schematic diagram of an internal combustion engine and starting system.

FIG. 2 is a chart plotting torque vs. engine speed for a starting system.

FIG. 3 is another chart plotting torque vs. engine speed.

FIG. 4 is a flowchart representing the operation of an automatic stop-start system.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION OF THE INVENTION

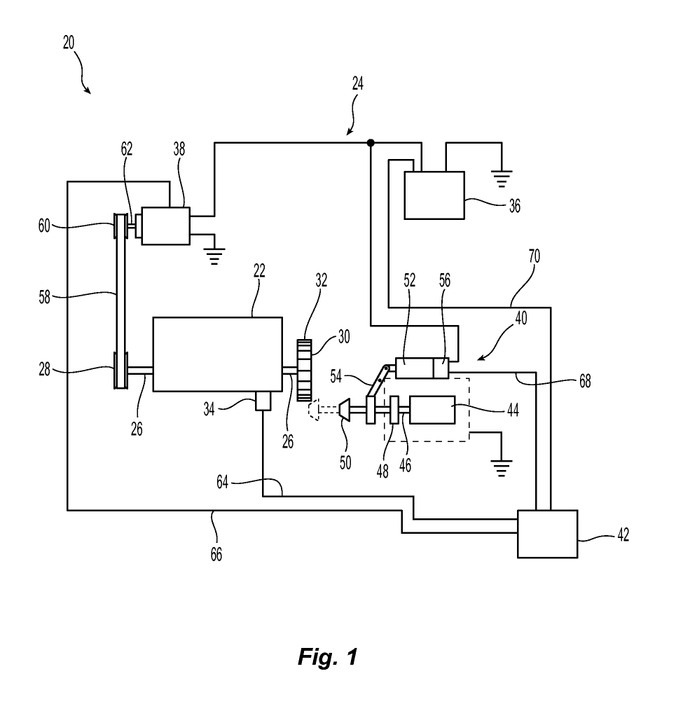

A vehicle 20 having an internal combustion engine 22 and starting system 24 is schematically depicted in FIG. 1. Internal combustion engine 22 may be a gasoline or diesel engine and includes a crankshaft 26. In the illustrated embodiment, an engine pulley 28 and a flywheel 30 are mounted on crankshaft. The illustrated flywheel 30 includes a ring gear 32 disposed along its outer perimeter. Starting system 34 is used to start engine 22 and includes a battery pack 36, an electric machine 38, starter assembly 40 and electronic control unit (“ECU”) 42.

Starter assembly 40 has a starter motor 44 with a shaft 46 coupled to a pinion gear 50. Located between shaft 46 and pinion gear 50 is a gear set 48 and an overrunning clutch (not shown). The overrunning clutch allows motor 44 to transmit torque to pinion gear 50 but prevents pinion gear 50 from transmitting torque to motor 44. The use of such an overrunning clutch is well known in the art and is used to prevent damage to starter motors when the speed of the engine being started overtakes the speed of the starter motor.

Gear set 48 is a reduction gear set whereby the rotational speed of motor shaft 46 will be higher than the rotational speed of pinion gear 50. Pinion gear 50 can be selectively coupled to ring gear 32 whereby starter motor 44 delivers torque to crankshaft 26 when motor 44 is energized and pinion gear 50 is engaged with ring gear 32 located on flywheel 30.

A solenoid 52 is used to move a shift lever 54 which selectively biases pinion gear 50 into or out of engagement with ring gear 32. In the embodiment of FIG. 1, a separate motor relay 56 is used to selectively energize starter motor 44 independently of the operation of solenoid 52. This allows the starter motor 44 to be energized independently of the movement of pinion gear 50 into and out of engagement with ring gear 32. The independent operation of motor 44 and pinion gear 50 can be advantageous if it is desirable to engage pinion gear 50 with a spinning ring gear 32. For example, starter motor 44 could be energized before engaging pinion gear 50 with ring gear 32 and solenoid 52 would be energized to shift pinion gear 50 into engagement after the speeds of pinion gear 50 and ring gear 32 were sufficiently synchronized.

Alternative embodiments, however, use solenoid 52 to both control the movement of pinion gear 50 and energize starter motor 44. In such single solenoid embodiments, pinion gear 50 will be biased into engagement with ring gear 32 whenever starter motor 44 is energized. Of course, solenoid 52 and relay 56 could be energized at substantially the same time to thereby substantially simultaneously bias pinion gear 50 into engagement and energize motor 44 in the same manner as a single solenoid embodiment. The advantage of a single solenoid embodiment is that it reduces the number of parts, and thus cost, of the starter assembly.

Turning now to electric machine 38, this electric machine can be selectively operated as either a motor drawing electric power from battery pack 36 and delivering torque to crankshaft 26 or as a generator drawing torque from crankshaft 26 and recharging battery pack 36. Electric machines that can be selectively operated as either a motor or a generator are often referred to as motor/generators or, when used in a vehicle, as an alternator.

Electric machine 38 is coupled with crankshaft 26 with a belt 58 that connects engine pulley 28 on crankshaft 26 with pulley 60 on electric machine 38. ECU 42 controls the operation of electric machine 38 and determines whether electric machine 38 will operate as a motor or generator depending upon the status of various vehicle operating parameters. In the illustrated embodiment, pulley 60 is coupled with electric machine 38 by mounting pulley 60 directly on shaft 62 which also functions as the rotor shaft of electric machine 38. Alternative embodiments, however, could utilize separate shafts for the motor shaft and pulley shaft and include a gear set or other mechanism between the two separate shafts.

In the illustrated embodiment, belt 58 constantly couples pulley 60 to engine pulley 28 and does not allow for the disengagement of the two pulleys 28, 60. The relative relationship between the diameters of the two pulleys 28, 60 defines the reduction ratio between motor shaft 62 and crankshaft 26. In other words, the relative size of the two pulleys defines how many rotations of motor shaft 62 will occur for each rotation of crankshaft 26. If electric machine 38 includes an internal gear set or similar mechanism, the operation of the gear set or other mechanism would also need to be accounted for to determine the reduction ratio between motor shaft 62 and crankshaft 26.

Starter assembly 40 also defines a reduction ratio between starter motor shaft 46 and crankshaft 26. The reduction ratio of starter assembly/starter motor 44 is defined by gear set 48 and the relative relationship between pinion gear 50 and ring gear 26. In the illustrated embodiment starter motor 44 has a reduction ratio that is larger than the reduction ratio of electric machine 38. In other words, when the starter assembly 40 and electric machine 38 are both coupled to crankshaft 26 during rotation of crankshaft 26, the starter motor 44 will define a greater rotational speed than the electric machine 38.

It will generally be advantageous to employ a reduction ratio with starter motor 44 that is larger than the reduction ratio of electric machine 38. One reason for employing a larger reduction ratio with starter motor 44 is that starter motor 44 can be decoupled from crankshaft 26 after starting engine 22 and engine 22 reaches a higher operational speed. Electric machine 38, on the other hand, will need to be coupled with a running engine when drawing torque from engine 22 to recharge battery pack 36.

The difference in reduction ratio will generally result in difference performance characteristics for the starter motor 44 and electric machine 38. For example for conventionally sized starter motors and motor/generators, when starting an engine that is at rest, i.e., crankshaft 26 is not rotating, starter motor 44 with its larger reduction ratio will supply greater torque to crankshaft 26 than electric motor 38 at low rotational speeds. On the other hand, after crankshaft 26 reaches a sufficiently high rotational speed that starter motor 44 will need to be de-coupled from crankshaft 26 to prevent damage to starter motor 44; electric machine 38 will still be able to supply torque to crankshaft 26. Another advantage of an electric machine that is continuously coupled to the crankshaft with a belt, such as electric machine 38 in the illustrated embodiment, is that it removes the necessity to synchronize the electric machine with the engine crankshaft when starting the engine while crankshaft is still rotating because the electric machine will already be coupled thereto and, thus, synchronized. As further discussed below, the present application discloses the use of starter motor 44 and electric machine 38 in a manner that take advantages of the relative strengths of both starter assembly 40 and electric machine 38.

Vehicle 20 employs an automatic stop-start system wherein ECU 42 automatically shuts down engine 22 and then restarts engine 22 based on the operating parameters of vehicle 20. ECU 42 receives signals from engine sensors 34 via a communication line 64. Similar communication lines provide ECU 42 with information on other vehicle systems and allow ECU 42 to communicate control signals to the various subsystems and individual components of vehicle 20. For example, in the illustrated embodiment, line 66 provides communication between ECU 42 and electric machine 38, line 68 provides communication between ECU 42 and solenoid 52 and motor relay 56 while line 70 communicates the voltage of battery back 36 to ECU 42.

ECU 42 is programmed to automatically stop engine 22 when certain conditions are satisfied, e.g., the operator is depressing the brake pedal, the vehicle speed is lower than a predefined limit and both the battery voltage and the engine temperature are above a predefined limits. After automatically stopping engine 22, ECU will automatically restart engine after ECU 42 detects certain conditions. For example, if the operator releases the brake pedal the engine will be restarted, or, if the battery voltage or engine temperature falls below a threshold value the engine will be restarted. As those having ordinary skill in the art will recognize, various different combinations of operating parameters can be used to determine when engine 22 will be automatically stopped and subsequently restarted. When restarting engine 22, engine may have already come to a complete rest, i.e., crankshaft 26 is no longer rotating. Alternatively, the engine may still be coasting due to inertia, i.e., crankshaft 26 is still rotating. For example, if ECU 42 stops engine 22 and the operator almost immediately thereafter releases the brake pedal, engine 22 will likely still be coasting at the time when it is desirable to restart engine 22. As discussed further below, different approaches may be used when restarting a coasting engine 22 with starting system 24.

Starting system 24 will also start engine 22 upon the initiation of the vehicle operator. Operator initiated starting events are commonly referred to as “key-starts” because, typically, the operator will insert and rotate a key to initiate the starting process. Keyless ignition systems are also in use, however, and the term “key-start” as used herein refers to any operator initiated starting event regardless of whether or not an actual key is used by the operator. In the illustrated embodiment, ECU 42 assumes that engine 22 is at rest and crankshaft 26 is not rotating when a key-start is initiated. Alternative embodiments which do not rely upon this assumption and instead determine or estimate the rotational speed of crankshaft 26 when performing a key-start, however, could also employ the starting system architecture and principles of operation disclosed herein.

It is noted that the illustrated ECU 42 which controls the operation of starting system 24 is a separate component that also controls a number of other vehicle systems and operations. Alternative embodiments, however, utilize a “distributed” ECU comprising several separate processors located at individual components of the starting system. For example, separate processors mounted on electric machine 38 and on starter assembly 40 could work in tandem to accomplish the same control functions as ECU 42. Alternatively, one of the assemblies, e.g., starter assembly 40, could include a separate processor that worked in tandem with ECU 42. In some circumstances, such a “smart” starter assembly and/or electric machine might possibly be installed in an existing vehicle to provide upgraded performance.

It is further noted that both electric machine 38 and starter motor 44 are powered solely by battery pack 36 when starting and restarting engine 22. This arrangement allows starting system 24 to be employed in conventional automobiles which rely solely on an internal combustion engine for propulsion as well as hybrid vehicles which rely on some combination of internal combustion engine propulsion and electrical motor propulsion. Hybrid vehicles typically employ two independently operating battery packs while conventional vehicles typically have only a single battery pack.

The illustrated battery pack 36 is a conventional starting battery pack and not a battery pack designed for powering a traction electric motor such as those commonly found in a hybrid vehicle. Although battery pack 36 is referred to as a “pack”, it may take the form of a single battery as well as a combination of several batteries. For example, battery pack 36 may take the form of an individual conventional 12 volt automobile battery when vehicle 20 is a passenger vehicle. When vehicle 20 is a larger vehicle, e.g., a truck having a large diesel engine, battery pack 36 may be formed by a plurality of individual batteries arranged in series or parallel with each other, such as a 48 volt battery pack wherein a plurality of batteries are arranged in series.

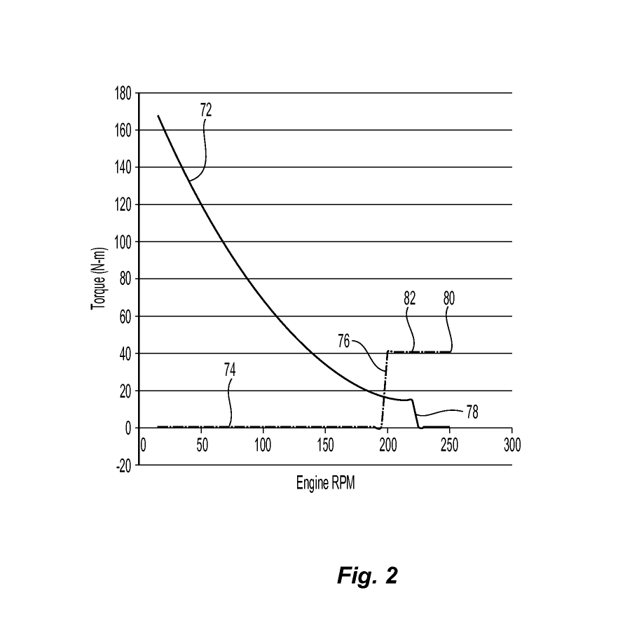

The operation of the starting system 24 will now be discussed. FIG. 2 provides a chart showing the supply of torque to crankshaft 26 from starter assembly 40 and electric machine 38 during a key-start starting event. In the chart of FIG. 2, curve 72 (solid line) represents the torque supplied by starter assembly 40 while curve 74 (dot-dash line) represents the torque supplied by electric machine 38.

During a key-start when the crankshaft speed, which corresponds to the RPM of the engine, is initially at zero, starter assembly 40 supplies torque to crankshaft 26 via flywheel 30 to initiate rotation of crankshaft 26. After the engine speed reaches a first predetermined engine speed during the starting process, electric machine 38 is energized and operated as a motor to supply torque to crankshaft 26 via engine pulley 28. This first predetermined engine speed is also referred to as a transfer speed herein because it is at this speed that the supply of torque to the crankshaft is beginning to be transferred from starter assembly 40 to electric machine 38. In FIG. 2, the transfer speed is approximately 200 RPM. Steeply inclined curve section 76 represents when electric machine 38 is energized and begins supplying torque to crankshaft 26 and corresponds to the transfer speed.

Starter motor 44 is de-energized at a second predetermined engine speed which, in FIG. 2, is at approximately 225 RPM. This second predetermined engine speed is also referred to herein as the “hand-off speed” because it is at this speed that the transfer of torque supply from starter assembly 40 to electric machine 38 is completed and the supply of torque has been completely handed over from starter assembly 40 to electric machine 38. Steeply falling curve section 78 represents when starter motor 44 is de-energized and stops supplying torque to crankshaft and corresponds to the hand-off speed.

After the supply of torque has been completely transferred to electric machine 38, electric machine 38 continues to supply torque to crankshaft 26 until the engine reaches a third engine speed which is greater than the hand-off speed and corresponds to autonomous engine combustion, i.e., starting of the engine. In other words, starter motor 44 is de-energized before engine 22 is started and it is electric machine 38 which finishes the starting process. In FIG. 2, autonomous engine combustion commences at an engine speed of approximately 250 RPM. This third engine speed is also referred to herein as the “termination speed” because it is at this speed that the starting process is terminated. Reference numeral 80 identifies the location on curve 74 when the supply of torque by electric machine 38 is terminated and engine 22 has been started.

As can be seen in the starting event represented in FIG. 2, starter assembly 40 initiates the starting event and transfers torque to crankshaft 26 during the initial stages of cranking engine 22, then, electric machine 38 is energized and the transfer of torque is handed over to electric machine 38. This allows starter assembly 40 to provide the torque at the low engine speeds when starter assembly 40 is capable of supplying a high torque and then transfers the supply of torque to electric machine 38 as the engine speed rises the capability of the starter assembly 40 to supply torque falls. This also allows electric machine 38 to continue to supply torque to engine 22 at significant levels at relatively high engine speeds thereby taking advantage of the relative strength of starter assembly 40 at low speeds and electric machine 38 at higher speeds.

As can also be seen in FIG. 2, by having the hand-off speed (curve section 78) at least as great as the transfer speed (curve section 76), starter motor 44 will not be de-energized before electric machine 38 begins operating as a motor and the supply of torque to crankshaft 26 will not be interrupted. As a person having ordinary skill in the art will understand, the total torque supplied to crankshaft 26 during the starting episode will be the sum of the two separate torque curves 72, 74.

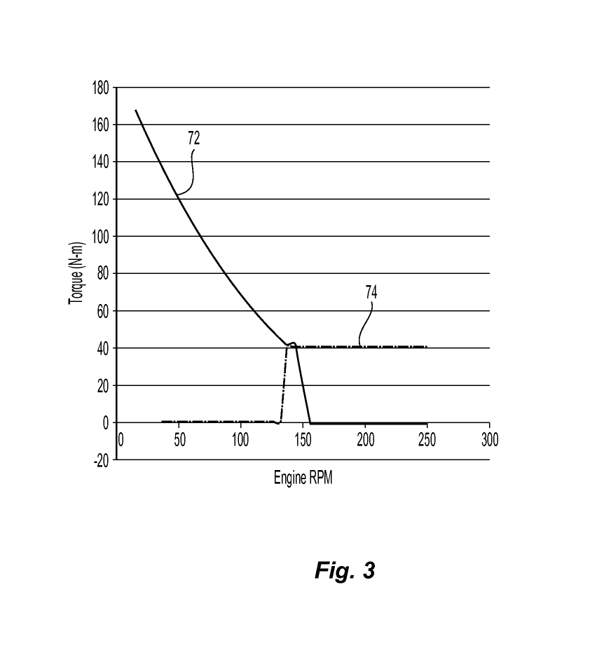

Once electric machine 38 begins operating as a motor, it provides a relatively stable level of torque to engine 22 over a range of engine speeds as can be seen in curve section 82. In the illustrated embodiment, the torque provided by electric machine 38 is approximately 40 Newton-meters. As can also be seen in FIG. 2, the torque provided by starter assembly 40 falls below 40 Newton-meters at an engine speed of about 140 RPM. By selecting a transfer speed that corresponds to where the torque provided by starter assembly 40 falls below that of electric machine 38, the engine will not experience a dip in the quantity of torque being supplied. Moreover, if the transfer speed and hand-off speed are substantially similar and occur at a speed where the torque respectively supplied by the starter assembly 40 and electric machine 38 are substantially similar, e.g., an engine speed of approximately 140 RPM in the illustrated embodiment, then the total quantity of torque supplied to crankshaft 26 will be subjected to fewer dramatic jumps or declines as the starting process proceeds. FIG. 3 illustrates this arrangement where the transfer and hand-off speeds are substantially similar and occur at a speed where the torque respectively supplied the electric machine 38 and starter assembly 40 are substantially similar.

The key-start process described above with reference to FIGS. 2 and 3, wherein both starter assembly 40 and electric machine 38 supply torque to engine 22 during the process, can be used as a starting system in a vehicle without an automatic-start stop system or starting system 24 can also be used to provide an automatic start-stop system. It is further noted that the automatic start-stop system discussed below can not only be provided in a starting system utilizing a key-start process as described above but also with a conventional key-start process utilizing only starter assembly 40 or only electric machine 38 to provide torque to engine 22 when performing a key-start of engine 22.

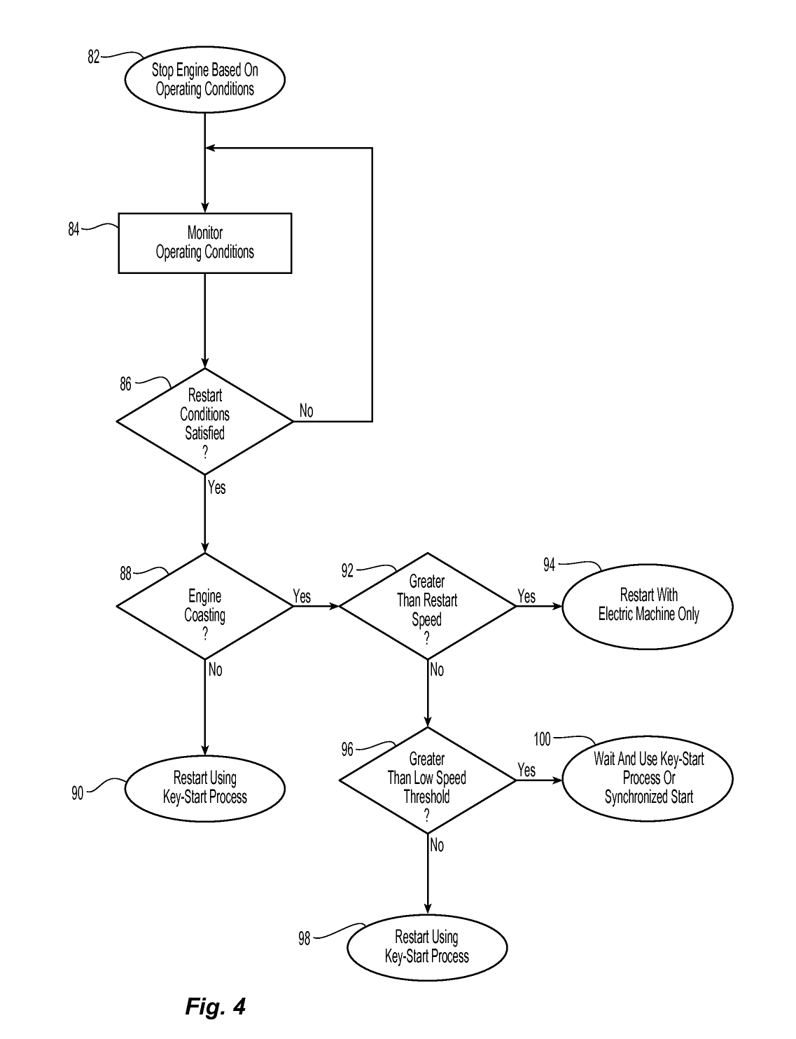

The operation of system 24 when functioning as a stop-start system will now be discussed. The flowchart of FIG. 4 illustrates the operation of one embodiment of the stop-start system which can be implemented through the control of starting system 24 with ECU 42. In FIG. 4, box 82 represents the situation when ECU 42 automatically stops engine 22 based upon the operating parameters of vehicle 20. Once ECU 42 has stopped engine 22, it continuously monitors the operating conditions of vehicle 20 to detect when the conditions for restarting engine 22. For example, when the operator releases the brake pedal or the engine temperature or battery voltage fall below a predetermined value, the conditions for restarting engine 22 will typically be satisfied. Box 84 represents the gathering of vehicle sensor and operating data by ECU 42 and box 86 represents the determination of whether or not such gathered information indicate that the vehicle operating conditions satisfy any of the conditions which would require the restarting of engine 22.

Once it is determined that engine 22 will be restarted, ECU 42 checks the signals provided by engine sensors 34 to determine if engine 22 is still coasting, i.e., crankshaft 26 is still rotating. If engine 22 has come to a complete stop and crankshaft 26 is no longer rotating, engine 22 is restarted using the same process as a key-start. In FIG. 4, box 88 represents the determination of whether or not engine 22 is still coasting by ECU 42 and box 90 represents the restarting of engine 22 using the key-start process, e.g., such as that described above with reference to FIGS. 2 and 3, which uses both starter assembly 40 and electric machine 38 in the starting process. It is noted that the reference to “key-start process” in the flowchart of FIG. 4 and the discussion of the automatic restarting of engine 22 simply means that ECU initiates a starting process employing starter assembly 40 and electric machine 38 in the same manner as when an actual key-start event occurs, it does not mean that the operator of vehicle 20 initiates the process.

If the engine is still coasting, ECU 42 determines if the engine speed is greater than a fourth predetermined engine speed which is also referred to herein as the restart speed. This determination is represented by box 92. If the engine speed is at least as great as the restart speed, ECU 42 restarts engine 22 by supplying torque to crankshaft 26 with electric machine 38 and without energizing starter motor 44. The restarting of a coasting engine 22 using only electric machine 38 is represented by box 94 of the flowchart in FIG. 4.

Advantageously, the restart speed is set at a speed which corresponds to the lowest speed at which electric machine 38 can reliably restart engine 22 without assistance from starter motor 44. When the restart speed is predefined to correspond to this value, the restart speed will likely be lower than the transfer speed at which electric machine 38 is initially energized during the key-start process. As mentioned above, electric machine 38 is continuously coupled, and thereby synchronized, with crankshaft 26 by means of pulleys 28, 60 and belt 58 and thereby facilitates the restarting of engine 22 when it is still coasting.

If the engine speed is less than the restart speed, ECU determines if the speed is greater than a fifth predetermined speed also referred to herein as the low speed threshold. If the engine speed is below the low speed threshold, the engine speed is sufficiently low that pinion gear 50 can be engaged with ring gear 32 without first pre-spinning pinion gear 50 and synchronizing its rotational speed with ring gear 32. In FIG. 4, box 96 represents the determination of whether or not the engine speed is below the low speed threshold.

When the engine speed is below the low speed threshold, ECU 42 restarts engine 22 by using a key-start process, e.g., by initially supplying torque to crankshaft 26 with starter assembly 40 and, after reaching the transfer speed, supplying torque to crankshaft 26 with electric machine 38.

If the restart speed is sufficiently low that it is no greater than the low speed threshold, the restart speed and low speed threshold will effectively be the same value. As a result, if the engine speed is determined to be less than the restart speed in box 92, this determination also means that the engine speed is less than the low speed threshold and the process can proceed directly to box 98 and restart engine 22 using a key-start process instead of repeating the same engine speed determination to confirm that the speed is less than the low speed threshold.

For some embodiments, however, the low speed threshold will be less than the restart speed. For such embodiments, there will be times when the engine speed is less than the restart speed and greater than the low speed threshold as represented by box 100 in FIG. 4.

Different embodiments may take different approaches to restarting engine 22 when the engine speed falls between the restart speed and low speed threshold. In one embodiment, when ECU 42 determines the engine speed is between the restart speed and low speed threshold and a restart is desired, ECU 42 will simply delay supplying torque to crankshaft 26 until the engine speed falls below the low speed threshold and will then restart the engine with the key-start process which will involve initially supplying torque with starter assembly 40. To implement this approach, ECU 42 can simply wait a predefined time period which will allow engine 22 to slow below the low speed threshold instead of continuously monitoring the engine speed.

When employing this approach, starter motor 44 is advantageously coupled with the crankshaft 26 (pinion gear 50 is engaged) and motor 44 energized at substantially the same time when initiating the supply of torque to the crankshaft. This approach advantageously allows for the use of a starter assembly 40 having only a single solenoid for both engaging pinion gear 50 and energizing starter motor 44.

If starter assembly 40 includes both a solenoid 52 for engaging pinion gear 50 with ring gear 32 and a separate motor relay 56 for energizing motor 44 to allow for the independent actuation of motor 44 and engagement of pinion gear 50, a different approach may be taken when restarting engine 22 when the engine speed is between the restart speed and low threshold speed. In this second approach, starter motor 44 is energized while uncoupled from crankshaft 26, i.e., pinion gear 50 is disengaged from ring gear 32, and starter motor 44 is coupled to crankshaft 26 by engaging ring gear 32 with pinion gear 50 to initiate the supply of torque to crankshaft 26 after the rotational speeds of starter assembly 40 and crankshaft 26 are synchronized, more particularly when the rotational speeds of pinion gear 50 and ring gear 32 are synchronized.

Other embodiments may employ electric machine 38 in a manner that rapidly slows engine 22 when stopping engine 22 as a part of an automatic stop-start system. For example, the field coils of electric machine 38 can be energized when engine 22 is automatically stopped. This will cause electric machine 38 to operate as a generator using torque from engine 22 to recharge battery pack 36. By placing a load on engine 22 in this manner, electric machine 38 will cause the engine to come to a complete stop more rapidly than if it were allowed to coast to a stop without any load being placed on the engine. As a result, when it is time to restart engine 22, it will be more likely that the engine has come to a complete stop and the process illustrated in FIG. 4 will restart the engine using a key-start process as depicted by element 90 wherein both ring gear 32 and pinion gear 50 will be at rest when initially engaged. If the engine is still coasting when a restart is desired, the operation of electric machine 38 as a generator immediately after stopping the engine will increase the likelihood that engine 22 will be rotating at a speed lower than the low speed threshold and the engine can be restarted using a key-start process as depicted by element 98. In such an embodiment, the energizing of the field coils and operation of electric machine 38 as a generator will cease when either engine 22 comes to a complete stop or the restart conditions are satisfied 86, whichever comes first.

As mentioned above, the starter system described herein can be used with a wide variety of vehicles. The automatic stop-start system described herein is particularly advantageous for use in relatively large vehicles having diesel engines. Such vehicles require significant torque when starting the engine and the ability to take advantage of the high torque provided by the starter assembly at low engine speeds and also take advantage of the ability of the electric machine to provide starting torque at high engine speeds is particularly advantageous. Moreover, very few of such vehicles are hybrid vehicles, the ability to use a single battery pack as the sole source of electrical power for both the starter motor 44 and electrical machine 38 for all starting and restarting of engine 22 facilitates the deployment of an automatic stop-start system in a non-hybrid vehicle having a large diesel engine, such as those employing a nominal 48 volt battery pack.

While this invention has been described as having an exemplary design, the present invention may be further modified within the spirit and scope of this disclosure. This application is therefore intended to cover any variations, uses, or adaptations of the invention using its general principles.

What is claimed is:

1. A starting system an internal combustion engine with a crankshaft, the starting system comprising:
a battery pack conductively coupled with the starting system;
starter assembly operably coupled with the starting system and having a starter motor selectively coupled with the crankshaft whereby the starter assembly is selectively operable to deliver torque to the crankshaft;
an electric machine operably coupled with the starting system; the electric machine being coupled with the crankshaft wherein the electric machine is selectively operable as a motor delivering torque to the crankshaft and as a generator recharging the battery pack; and
an electronic control unit operably coupled with the starting system and controlling operation of the starter assembly and electric machine; wherein, during a key-start of the engine, the starter assembly supplies torque to the crankshaft to initiate rotation of the crankshaft and the electric machine supplies torque to the crankshaft after a first predetermined engine speed is reached during the starting process; and
wherein both the starter motor and the electric machine are powered solely by the battery pack when starting the engine.

2. The starting system of claim 1 wherein the starter motor is de-energized at a second predetermined engine speed and the electric machine stops transferring torque to the crankshaft at a third engine speed which is greater than the second predetermined engine speed, the third engine speed corresponding to autonomous engine combustion.

3. The starting system of claim 2 wherein the second predetermined engine speed is at least as great as the first predetermined engine speed.

4. The starting system of claim 3 wherein the first and second predetermined engine speeds are substantially similar and wherein the torque respectively supplied by the electric machine and the starter motor at the first and second predetermined engine speeds is substantially similar.

5. The starting system of claim 1, wherein the electronic control unit is adapted to automatically start and stop the engine and wherein, when restarting the engine, the electronic control unit determines if the engine speed is at least as great as a fourth predetermined engine speed and, if the engine speed is at least as great as the fourth predetermined engine speed, restarts the engine by supplying torque to the crankshaft with the electric machine and without energizing the starter motor and wherein the electric machine is powered solely by the battery pack when restarting the engine.

6. The starting system of claim 5 wherein the fourth predetermined engine speed is less than the first predetermined engine speed.

7. The starting system of claim 5 wherein, if the engine speed is less than both the fourth predetermined engine speed and a fifth predetermined engine speed, the engine is restarted by initially supplying torque to the crankshaft with the starter assembly and, after reaching the first predetermined engine speed, supplying torque to the crankshaft with the electric machine; and wherein both the starter motor and the electric machine are powered solely by the battery pack when restarting the engine.

8. The starting system of claim 7 wherein the fourth and fifth predetermined engine speeds are the same.

9. The starting system of claim 7 wherein the fifth predetermined engine speed is less than the fourth predetermined engine speed.

10. The starting system of claim 9 wherein, when the electronic control unit determines the engine speed is between the fourth and fifth predetermined engine speeds and a restart is desired, the electronic control unit delays supplying torque to the crankshaft with the starter motor until the engine speed falls below the fifth predetermined engine speed.

11. The starting system of claim 10 wherein the starter motor is coupled with the crankshaft and energized at substantially the same time when initiating the supply of torque to the crankshaft.

12. The starting system of claim 9 wherein, when the electronic control unit determines the engine speed is below the fifth predetermined engine speed and a restart is desired, the starter motor is coupled with the crankshaft and the starter motor is energized at substantially the same time when initiating the supply of torque to the crankshaft; and, when the electronic control unit determines the engine speed is between the fourth and fifth predetermined engine speeds and a restart is desired, the starter motor is energized while uncoupled from the crankshaft and the starter motor is coupled to the crankshaft to initiate the supply of torque to the crankshaft when the rotational speeds of the starter assembly and the crankshaft are synchronized.

13. The starting system of claim 1 wherein the crankshaft has a flywheel and an engine pulley coupled thereto and wherein:
the starter assembly further comprises a gear coupled with the starter motor and selectively coupled with the flywheel whereby the starter assembly selectively delivers torque to the crankshaft; and
wherein a first pulley is coupled with the electric machine and a belt couples the first pulley with the engine pulley to thereby transfer torque between the crankshaft and the electric machine.

14. The starting system of claim 13 wherein, when both the starter assembly and the electric machine are coupled to the crankshaft during rotation of the crankshaft, the starter motor will define a greater rotational speed than the electric machine.

15. An automatic start-stop system for an internal combustion engine with a crankshaft, the start-stop system comprising:
a battery pack conductively coupled with the start-stop system;
starter assembly operably coupled with the start-stop system and having a starter motor selectively coupled to the crankshaft whereby the starter assembly is selectively operable to deliver torque to the crankshaft;
an electric machine operably coupled with the start-stop system; the electric machine being coupled with the crankshaft and selectively operable as a motor delivering torque to the crankshaft and as a generator recharging the battery pack; and
an electronic control unit operably coupled with the start-stop system and controlling operation of the starter assembly and electric machine; wherein, during a key-start of the engine, the starter assembly supplies torque to the crankshaft to initiate rotation of the crankshaft; and and wherein, when restarting the engine, the electronic control unit determines if the engine speed is at least as great as a predetermined restart speed and, if the engine speed is at least as great as the restart speed, restarts the engine by supplying torque to the crankshaft with the electric machine and without energizing the starter motor and wherein the battery pack is the sole source of electrical energy for the starter motor and the electrical machine when starting and restarting the engine.

16. The start-stop system of claim 15 wherein the battery pack is a nominal 48 volt battery pack.

17. The start-stop system of claim 15 wherein the crankshaft has a flywheel and an engine pulley coupled thereto and wherein:
the starter assembly further comprises a gear coupled with the starter motor and selectively coupled with the flywheel whereby the starter assembly selectively delivers torque to the crankshaft;
wherein a first pulley is coupled with the electric machine and a belt couples the first pulley with the engine pulley to thereby transfer torque between the crankshaft and the electric machine; and
wherein, when both the starter assembly and the electric machine are coupled to the crankshaft during rotation of the crankshaft, the starter motor will define a greater rotational speed than the electric machine.

18. The start-stop system of claim 17 wherein, during a key-start of the engine, the starter assembly supplies torque to the flywheel to initiate rotation of the crankshaft and the electric machine supplies torque to the engine pulley after the engine speed reaches a predetermined transfer speed during the starting process; and the starter motor is de-energized when the engine reaches a predetermined hand-off speed and the electric machine stops transferring torque to the engine pulley when the engine reaches a termination speed which is greater than the hand-off speed, the termination speed corresponding to autonomous engine combustion.

19. The start-stop system of claim 17 wherein, if the engine speed is less than the restart speed when a restart is desired, the restart of the engine is initiated by supplying torque to the flywheel with the starter assembly.

20. The start-stop system of claim 19 wherein, when a restart is desired and the electronic control unit determines the engine speed is between the restart speed and a predetermined low-speed threshold that is less than the restart speed, the electronic control unit delays supplying torque to the flywheel with the starter motor until the engine speed falls below the low-speed threshold and wherein the pinion gear is coupled with the flywheel and the starter motor is energized at substantially the same time when initiating the supply of torque to the flywheel.
